(19) United States
(12) Patent Application Publication
(10) Pub. No.: US 2023/0284827 A1
(43) Pub. Date: Sep. 14, 2023

(54) Kitchen Appliance System, Method of Controlling a Kitchen Appliance System and Control for a Kitchen Appliance System

(71) Applicant: Vorwerk & Co. Interholding GmbH, Wuppertal (DE)

(72) Inventors: Nils Beckmann, Remscheid (DE); Torsten Lang, Solingen (DE); Miron Sernecki, Hagen (DE); Felix Haunschild, Essen (DE); Kevin Schmitz, Haan-Gruiten (DE)

(21) Appl. No.: 18/117,688

(22) Filed: Mar. 6, 2023

(30) Foreign Application Priority Data
Mar. 7, 2022 (EP) 22160527.2

(51) Int. Cl. A47J 36/32; A47J 43/046; A47J 43/07

(52) U.S. Cl. CPC A47J 36/32; A47J 43/046; A47J 43/0766

(57) ABSTRACT

The invention relates to a kitchen appliance system with a base unit having a housing, a controller and a communication interface, and with at least one accessory having an identifier. In order to increase user-friendliness, it is proposed that a detector is provided and configured to detect an identifier of at least one accessory and to forward corresponding information to the controller, that a position detector is provided and configured to detect the position of the at least one accessory in relation to the base unit and/or in relation to a further accessory and to forward corresponding information to the controller, in that the controller is configured to recognise an accessory and its position on the basis of the forwarded information, and in that the controller is configured to automatically confirm a proper position or change in position of a recognised accessory and, in the event of an undetermined position or change in position or in the event of an undetected position or change in position, to automatically confirm the position of the accessory, position change or in the case of an unrecognised accessory, to output a corresponding user message. Also described are a corresponding method, a control system for controlling a kitchen appliance system and a corresponding computer program.

### CROSS-REFERENCE TO RELATED APPLICATION

This application claims priority to European Patent Application No. 22160527.2 filed Mar. 07, 2022, the disclosure of which is hereby incorporated by reference in its entirety.

### BACKGROUND OF THE INVENTION

### Field of the Invention

The invention relates to a kitchen appliance system with a base unit comprising a housing, a control device and a communication interface, and with at least one accessory comprising an identifier. The invention also relates to a corresponding method for controlling a kitchen appliance system and to a control system for a kitchen appliance system.

### Description of Related Art

Kitchen appliances of the type mentioned above are already known, in particular for processing raw or semi-finished food products. These kitchen appliances have a base unit with which separate functional parts interact to process a food product depending on the dish, drink or the like obtained. Functional parts are typically sold by food processor suppliers as accessories, for example, a cooking vessel, a cooking vessel, a lid, a cutting or mixing unit or the like. Generally, the accessory and the base unit each have interfaces that are compatible with each other and enable the two components to interact. In particular, interfaces brought into interaction with each other can be used to drive a movable element of the accessory by means of an electric motor arranged in the base unit.

Often, kitchen appliance systems are sold with a selection of preparation instructions, such as cooking recipes, according to which components of the kitchen appliance system can be controlled. In order to ensure that the correct accessories are used at the correct time, a manual confirmation by the user is usually requested for known kitchen appliance systems. In addition, it is known, for example from DE 102013111472 A1, to prevent a preparation step on the kitchen appliance system for safety reasons if it is not confirmed that the expected accessory is used as intended.

Thus, manual confirmation is an important, even sometimes necessary step in the process of preparation with a food processor of the known type. However, manual confirmation requires a certain amount of effort on the part of the user and is also a source of error that most familiar kitchen appliance systems cannot compensate for on their own. If, for example, a different accessory is used than expected or a safety-related accessory is forgotten and manual confirmation is still entered that the expected accessory has been used correctly, this can lead to failure of the preparation process or possibly to damage to the kitchen appliance system or danger to the user.

### SUMMARY OF THE INVENTION

Against this background, the present invention is based on the problem of improving known kitchen appliance systems, and in particular of specifying a kitchen appliance system, a method and a corresponding control system, wherein the user-friendliness and the chances of success of a preparation process are increased.

This problem is solved according to the invention with a kitchen appliance system with a base unit having a housing, a control device and a communication interface and with at least one accessory having an identifier, in that a detection device is provided and is configured to detect an identifier of at least one accessory and to forward corresponding information to the control device, in that a position detector is provided and is configured to detect the position of the at least one accessory in relation to the base unit and/or in relation to a further accessory and to forward corresponding information to the control device, in that the control device is configured to detect the position of the at least one accessory on the basis of the information forwarded to the control device and to forward corresponding information to the control device, the position of the at least one accessory with respect to the base unit and/or with respect to a further accessory and to forward corresponding information to the control device, in that the control device is configured to recognise an accessory and its position on the basis of the forwarded information, and in that the control device is configured to automatically confirm a proper position or change in position of a recognised accessory and, in the event of an undetermined position or change in position or in the event of an undetected position or change in position, to automatically confirm the position of the recognised accessory. position change or in the case of an unrecognised accessory, the control device is configured to automatically confirm a proper position or position change of a recognised accessory and to output a corresponding user message.

By automatically recognising the accessory and its position, the control device automatically performs a confirmation and informs the user if the position is not the one provided in a preparation instruction. This way, the confirmation is done safely and with a lower error rate. It also eliminates the need for manual user input, resulting in increased user comfort. In addition, the overall time required is reduced, because automatic confirmation is usually faster than manual input or confirmation.

The solution according to the invention is advantageous both for carrying out a preparation process with digital, assisted cooking and without assistance. For example, an accessory can simply be assembled with the base unit and its proper position automatically confirmed, so that functions of the kitchen appliance system that are blocked for safety reasons without valid confirmation are automatically enabled. If a preparation instruction has been selected which, for example, requires confirmation of the assembly of a certain accessory, then the kitchen appliance system according to the invention can automatically confirm such an actual assembly and simply continue with the preparation process according to the preparation instruction.

A base unit in the sense of the present invention is preferably designed as a base for the use of accessories by having an interface for interaction with at least one accessory. The base unit has a housing wherein an electric motor for driving accessories is arranged. The electric motor then interacts with an accessory assembled with the base unit via the interface of the base unit.

Accessory is understood to be any part designed for interaction with the base unit. The accessory may be directly or indirectly assembled with the base unit, wherein for direct assembly the accessory has an interface compatible with the interface of the base unit, and wherein for direct assembly the accessory is attached to another accessory which is in turn directly assembled with the base unit. The term “assembly” includes, but is not limited to, the actions from the list: Connecting, coupling, mounting, attaching, fitting and the like. In particular, an accessory is designed to extend the function of the base unit, for example as a cutting, stirring, cooking, weighing, cooking, steaming or covering unit. The function for which the accessory is intended preferably designates the type of accessory.

The term identifier includes any information about at least one property of the accessory. Preferably, the identifier is sufficient to identify an accessory or to be able to assign it in the context of a database. An identifier in the sense of the invention may be selected from the non-exhaustive list: Accessory type, such as cutting, stirring, cooking, weighing, cooking, steaming or covering unit; Origin information, such as manufacturer identity, date of manufacture, place of manufacture; Authentication information; Identification number, such as a serial number or a Universally Unique Identifier (UUID). Preferably, the identifier has been assigned by the accessory manufacturer prior to distribution or during production.

The information feature is preferably stored on a data carrier which is integrated in the base body of the accessory or permanently attached to the base body of the accessory. Several data carriers can be provided, each of which carries an identifier and which are arranged at different positions on the accessory. Thus, depending on the position of use or the direction wherein the accessory is assembled with the base unit, an identifier corresponding to the position of use can be detected. Alternatively or additionally, a data carrier can have several identifiers, each of which is detected depending on the assembly position of the accessory on the base unit. In particular, a data carrier can be switchable, for example with the aid of a magnet, and provide a corresponding identifier for detection depending on the switching position or switching state. In this way, a suitable quick-start mode can be automatically called up for an accessory that can assume several operating positions on the base unit, depending on its current operating position.

The detection device or detector is configured to detect the identifier of the accessory. If, for example, the identifier is attached to the accessory in the form of a QR code, the detection device is preferably designed as an optical reader. The detection device can also be a reader for a data memory connected to an RFID antenna, a part of a short-range radio system (e.g. Bluetooth, ultra-wide band (UWB) or WLAN) or a part of a bus system. The detection device can be arranged at the base body or be designed as a device separate from the base body and the accessory, for example as a smartphone with a detection element such as an integrated camera, which is connected directly or indirectly via the communication interface to the control device of the base unit for a data exchange.

Furthermore, the detection device may be connectable via a communication link to a detection element arranged at a first accessory. The detection element is preferably configured to detect an identifier of a further accessory. In this way, the further accessory can first be recognised and then be used for intended use on the base unit or on the first accessory. This is particularly advantageous for accessories whose identifier is difficult to detect in the intended use position, in particular due to insufficient signal transmission through the base of a first accessory designed as a cooking unit.

The position of an accessory in the sense of the present invention is defined in relation to the base unit and/or in relation to another accessory. Thus, a position of an accessory may be a distance from a reference point on the base unit or on another accessory, a connection state of mutually compatible interfaces or the like. If an accessory is mounted directly on the base unit, for example by connecting an interface of the accessory to an interface of the base unit, then the accessory is directly assembled with the base unit. Another example of a position within the meaning of the present invention is a condition wherein a first accessory is added to a further accessory, the further accessory being assembled with or attached to the base unit. Here, the first accessory is indirectly assembled and the further accessory is directly assembled with the base unit. An accessory can also, for example, be in a position wherein it is removed from the base unit or incorrectly assembled with the base unit. The absence of an accessory is also understood as the position of the accessory concerned.

A proper position or intended position in the sense of the invention can in particular be a state which permits interaction with the base unit intended for the function of the accessory concerned. For example, a proper position for an accessory intended for direct assembly on the base unit may be a condition wherein respective mutually compatible interfaces of the accessory and the base unit are connected for drive by the electric motor or control of a heating element of the accessory.

The position of an accessory is a real position detected by the position detector. In addition, a proper position is preferably defined in advance and stored as machine-readable information on a storage medium, which the control device can access in order to carry out a comparison with the detected position and thus also to determine whether the detected position corresponds to the intended, proper position. Preferably, the machine-readable information on the proper position is stored in the context of preparation instructions for a preparation process.

A “change in position” is understood to be a difference between a position detected at a first time and a position detected at a later time. For example, a first detection operation may result in the absence of an accessory, or a position of an accessory may be determined to be “removed”, and a further detection operation carried out at a later time may result in an assembly of the accessory on the base unit, or a position may be determined to be “assembled”, where the term “ assembled ” includes in particular the positions from the non-exhaustive list: connected, coupled, mounted, attached, applied, and the like. Overall, the corresponding change in position is an assembly of the accessory to the base unit. If a position is first determined as “assembled” and later a position “removed”, then the resulting position change is a removal. Also, a difference between an incorrect or improper position and a proper position is a position change.

Preferably, previously defined, proper position changes are stored as machine-readable information on a storage medium, which the control device can access in order to carry out a comparison with the detected position change and thus also to determine whether the detected position change corresponds to the intended, proper position change. Preferably, the machine-readable information on the proper position change is stored in the context of preparation instructions for a preparation process. For example, preparation instructions with an identifier for an accessory and with a proper position change as “assembly” can be stored in the database.

The position sensing device provided for detecting the position or change in position of the accessory may, for example, be a dedicated device cooperating with an element on the accessory and/or a weighing module. Alternatively or additionally, the detection device for detecting an identifier may function as a position detector by detecting an assembly when an identifier enters the detection field of the detection device and detecting a removal when an identifier exits the detection field of the detection device. Alternatively or additionally, the position detector can be designed as a separate device from the base unit and the accessory and can be connected to the control device via the communication interface.

The position detector can be arranged in the accessory and/or in the housing of the base unit. Preferably, the accessory has at least one element which is configured to influence the position detector, and the position detector is configured to output information with position information depending on the influence by the element.

In particular, the interaction of the element of the accessory with the position detector may be designed as follows:
Opening or closing an electrical contact between the element on the accessory and the position sensing device by changing the position of the accessory relative to the base unit;
opening or closing of a magnetic contact, for example a reed contact, between an element formed as a magnet on the accessory and the position sensing device by changing the position of the accessory relative to the base unit;
detecting a change in inductance or capacitance caused by interaction of a metal part on the accessory and an active detection element of the position detector; and/or
detection of the intensity of the magnetic field of a magnet arranged at the accessory by an active detection element of the position detector.

Furthermore, the control device is preferably arranged in the housing or on the housing of the base unit and preferably comprises a processor with a storage medium. In particular, a computer program with instructions may be stored on the storage medium, the execution of which by the processor causes the kitchen appliance system to perform an operating procedure.

The storage medium may store a database of identifiers, preparation instructions, preparation instructions and/or machine-readable information regarding proper positions for accessories.

Preferably, such a database is stored on the storage medium of the control device that access to an external source of information or to an external database can be dispensed with during operation. The kitchen appliance system, in particular the control device, can be configured in such a way that the control device accesses an external database if the information stored in the database on the storage medium of the database is not sufficient. For example, when an accessory is used for the first time, the control device may access an external database to download preparation instructions, identifiers and/or predefined proper positions for that accessory to its storage medium. In addition, the control device is preferably connectable to an external server, for example a server of the kitchen appliance system manufacturer, for access via the internet.

Preferably, the control device for data exchange is in communication with the detector and with the position detector respectively. Wireless or wired communication links between the respective devices can be provided for this purpose.

The control device or controller is configured to recognise an accessory and its position on the basis of the information forwarded by the detector and the position detector. For this purpose, the control device is preferably configured to compare the information from the forwarded or received information in each case with identifiers and predefined, proper positions from a database. From the result of the comparison, the control device is then able to determine whether an accessory is already known or registered from the database and whether its detected position corresponds to a proper position for this accessory.

Furthermore, the control device is configured to automatically confirm a designated position or change in position of a detected accessory. Thus, the confirmation is carried out by and for the control device, i.e. preferably without manual input. In particular, in the context of preparation instructions with several successive preparation steps, where a first preparation step consists of assembling a specific accessory, the first preparation step can be automatically completed by the confirmation and the next preparation step can be instructed.

In accordance with the internal confirmation, the control device may provide a user indication that the correct accessory is positioned as intended. Alternatively, a user indication regarding a successful automatic confirmation may be omitted or the provision of such a user indication may be shortened in time.

Furthermore, the control device is configured to output a corresponding user message in the event of an improper position or change in position or in the event of an unrecognised accessory. The case of an unrecognised accessory is given in particular if a comparison of a detected identifier with identifiers from a database carried out by the control device does not result in a match. In addition, the case of an improper position is given in particular if the detected position does not correspond to any predefined proper position stored in a database.

According to a first embodiment of the kitchen appliance system, the control device is configured to control components of the kitchen appliance system according to at least one predetermined preparation process and to automatically adjust the course of a preparation process depending on the detected position or change in position and on the detected identifier.

In this way, as part of a digitally assisted preparation process, for example by issuing instructions in accordance with digitally stored preparation instructions selected by a user, the base unit can be automatically controlled depending on the position of a recognised accessory and manual user input to confirm the use of the accessory can be dispensed with.

The course of a preparation process can be adapted, for example, by starting the electric motor of the base unit when the assembly of a stirring unit is detected, or by activating a weighing module when the assembly of a cooking vessel with contents is detected. Other examples include setting a direction of rotation for the electric motor, setting a torque for the electric motor, activating and/or setting a control for a heating element.

If, on the other hand, an accessory that is expected or recommended according to the currently selected preparation instructions is missing, a waiting time can be started and the control device can carry out a detection process after the waiting time has elapsed so that the user is given time to bring the accessory into the expected position.

According to a further embodiment of the kitchen appliance system, the control device is configured to automatically provide instructions for preparation steps of at least one preparation process via the communication interface as a function of the detected position or change in position and of the detected identifier.

This allows instructions to be issued that are appropriate for the current state of the kitchen appliance system and thus also better support the user for carrying out a preparation process.

In particular, the control device may be configured to stop providing an instruction concerning assembly or removal of an accessory when a corresponding intended change of position of the accessory is detected and, if necessary, to provide an instruction for a subsequent preparation step.

The communication interface provided can be a user interface in the form of an acoustic, haptic or visual display, but also an interface for forwarding information to a user terminal such as a smartphone or a digital home management system. Thus, the communication interface provides information directly, i.e. for example itself as a display, or indirectly via an additional user interface.

According to a further embodiment of the kitchen appliance system, an assembly or removal of at least one accessory is recommended for carrying out a preparation step and the control device is configured to automatically confirm this and complete the corresponding preparation step or provide an instruction for a subsequent preparation step when a corresponding, intended assembly or removal of the at least one recommended accessory is detected.

In this way, the kitchen appliance system is able to independently manage the preparation steps of a preparation process according to the preparation instructions and taking into account the detected information. This not only eliminates the need for user input to confirm a correctly positioned accessory, but also eliminates the need for user input to continue the preparation process.

Alternatively or additionally, the control device ca provide an instruction for a preparation step again, for example if a premature removal of an accessory is detected.

According to a further embodiment of the kitchen appliance system, the control device is configured to carry out a renewed detection process after a predetermined period of time has elapsed when an improper assembly or an improper removal is detected during a first detection process, and to provide a corresponding user instruction when an improper assembly or an improper removal is detected during the renewed detection process and to prevent a preparation step from being continued on the kitchen appliance system.

In this way, in addition to indicating an improper position of the accessory, the user can also be given the opportunity to correct the incorrect position in order to then continue the preparation process. Furthermore, when an incorrect position is detected, even after the predetermined time period has elapsed, damage to the kitchen appliance system due to the incorrect position can be avoided.

According to a further embodiment of the kitchen appliance system, an assembly of at least one accessory is recommended for carrying out a preparation step and the control device is configured to automatically provide a corresponding user instruction when the absence of the at least one recommended accessory is detected during a first detection process and to carry out a renewed detection process after a predetermined time period has elapsed.

Thus, if an accessory is missing, the user is given the opportunity to assemble the accessory. If the further detection process detects that the recommended accessory has been assembled as intended, this can be confirmed automatically and the preparation process can be continued.

According to a further embodiment of the kitchen appliance system, an assembly of at least one accessory is required for carrying out a preparation step, and the control device is configured to automatically provide a corresponding user instruction when the absence of the at least one required accessory is detected and to prevent a preparation step from being continued on the kitchen appliance system until a proper assembly of the required accessory is detected.

This increases the safety of the kitchen system not only for the user, but also in terms of material damage that can occur if a required accessory is not used.

In the context of a preparation instruction, according to which a preparation process is carried out, it can be defined, for example, that a cover is also required when a cutting unit is used. If the control device detects the use of a cutting unit and the absence of a cover at the same time, it can prevent the cutting unit from being driven by the electric motor until the use of the required cover is detected.

According to a further embodiment of the kitchen appliance system, there is a preparation instruction with a sequence of preparation steps with corresponding instructions and the control device is configured to skip a provision of an instruction concerning an assembly or removal of an accessory if a corresponding proper position change of the accessory has already been detected in time before the provision of this instruction and/or if a corresponding proper position is detected.

Correctly assembling or removing an applicable accessory before an instruction is displayed may make that instruction redundant. With the specified kitchen appliance system, the provision of such instructions can be prevented and thus the overall user-friendliness can be increased. Even if a recommended accessory is already available, the superfluous request to use it can be prevented.

Preferably, there are preparation instructions with a predetermined chronological order of instructions, at least one of which concerns the assembly or removal of an accessory.

The above-mentioned problem is also solved by a method for controlling a kitchen appliance system, in particular a kitchen appliance system according to one of the explained embodiments, wherein an identifier of at least one accessory is detected, wherein the position of the at least one accessory is detected with respect to the base unit and/or with respect to a further accessory, wherein an accessory and its position are detected on the basis of the detected identifier and the detected position, and wherein a proper position or change in position of a detected accessory is automatically confirmed and, in the case of an improper position or change in position or in the case of an unrecognised accessory, the position of the accessory is automatically confirmed, position change or in the case of an unrecognised accessory, a corresponding user message is output.

The method and the embodiments of the method explained below have the same advantages as the corresponding embodiments of the kitchen appliance system.

In the method according to the invention, the steps of detecting an identifier and detecting a position or change in position can be carried out one after the other in this order, one after the other in reverse order or in parallel.

An accessory is preferably identified by the control device by comparing the detected identifier with identifiers from a database, whereby an accessory is deemed to be recognised if the detected identifier matches at least one identifier from the database. If the comparison does not result in a match, then the accessory is deemed not to be recognised. In this case, it is preferably possible to register the accessory automatically by manual input or by storing a corresponding computer programme code, wherein the detected identifier is stored in the database for subsequent uses of the accessory on the base unit. Similarly, a designated position of a detected accessory is detected by comparing the detected position with at least one designated position predefined specifically for the accessory and linked in the database with the identifier of the accessory. This also applies to the detection of a change in position of the accessory. For example, a proper position for a cover unit may be a correct assembly on a matching cooking vessel. Another example of a proper position of an accessory is a correct placement of a cutting unit on a drive shaft in a cooking vessel.

The identification process, wherein an identifier is detected and compared with identifiers from a database, and the position recognition process, wherein a position or position change is detected and compared with positions or position changes from the database, are preferably carried out one after the other. Since a designated position is linked and stored in the database with each identifier, a designated position or change in position can be more easily recognised by the sequence with first an identification process and then a position recognition process.

Alternatively, the sequence of identification and position detection operations can be interchanged, whereby a positive match of a detected information of the first operation performed leads to the execution of the next operation.

According to a first embodiment of the method, components of the kitchen appliance system are controlled according to at least one predetermined preparation process, wherein the course of a preparation process is automatically adjusted depending on the detected position or change in position and on the detected identifier.

According to a further embodiment of the method, instructions for preparation steps of at least one preparation process are automatically provided via the communication interface as a function of the detected position or change in position and of the detected identifier, in particular an instruction concerning the assembly or removal of an accessory is skipped if a corresponding proper position or change in position of the accessory was already detected before this instruction was made available.

According to a further embodiment of the method, an assembly or removal of at least one accessory is recommended for carrying out a preparation step, and when a corresponding, intended assembly or a corresponding, intended removal of the at least one recommended accessory is detected, this is automatically confirmed and the corresponding preparation step is completed or an instruction for a subsequent preparation step is provided.

According to a further embodiment of the method, when an improper assembly or an improper removal is detected during a first detection process, a new detection process is carried out after a predetermined period of time has elapsed, and when an improper assembly or an improper removal is detected during the new detection process, a corresponding user instruction is provided and a continuation of a preparation step on the kitchen appliance system is prevented.

According to a further embodiment of the method, an assembly of at least one accessory is recommended for carrying out a preparation step and, when the absence of the at least one recommended accessory is detected during a first detection process, a corresponding user instruction is automatically provided and a new detection process is carried out after a predetermined time period has elapsed. Alternatively, an assembly of at least one accessory is required for carrying out a preparation step and, when the absence of the at least one required accessory is detected, a corresponding user instruction is automatically provided and a continuation of a preparation step on the kitchen appliance system is prevented until a proper assembly of the required accessory is detected.

The above-mentioned problem is also solved by a control system for controlling a kitchen appliance system, in particular a kitchen appliance system according to one of the explained embodiments, according to a method according to one of the explained embodiments.

This control system also has the same advantages as the kitchen appliance system and its embodiments.

Furthermore, the above-mentioned task is solved by a computer program comprising instructions, the execution of which on at least one processor of a control device of a kitchen appliance system according to one of the embodiments described above causes the execution of a method according to an embodiment example explained above.

### BRIEF DESCRIPTION OF THE DRAWINGS

Further features and advantages of the present invention will be apparent from the following description of examples of embodiments, reference being made to the accompanying drawing.

In the drawing show

FIG. 1 an embodiment of a kitchen appliance system in a first case constellation,

FIG. 2 the kitchen appliance system of FIG. 1 in a further case constellation,

FIG. 3 the kitchen appliance system of FIG. 1 in a further case constellation and

FIG. 4 an example of a method for controlling a kitchen appliance system.

### DESCRIPTION OF THE INVENTION

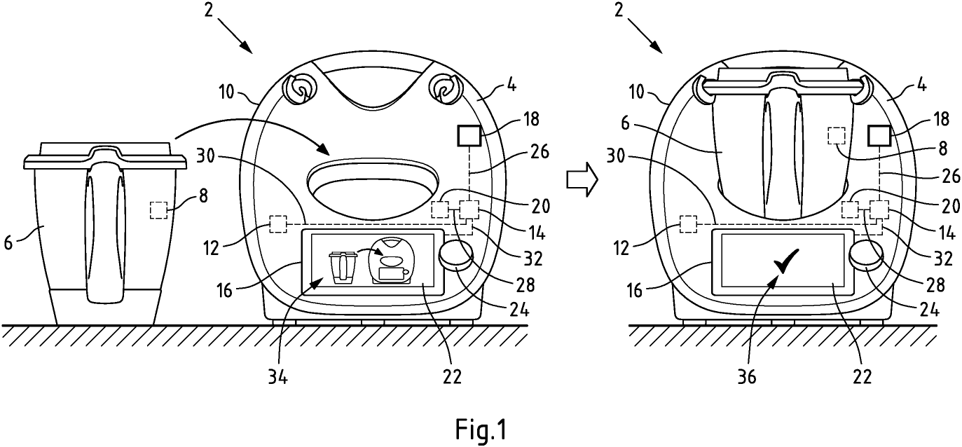

FIG. 1 shows a kitchen appliance system 2 in a first embodiment with a base unit 4 and with an accessory 6. The accessory 6 is designed as a cooking vessel and has an RFID module 8 with an identifier. The base unit 4 has a housing 10, an electric motor 12 for driving a functional part of an accessory 6, a controller 14 and a communication interface 16.

A detector 18 and a position detector 20 are also provided on the base unit 4, which are each configured to detect the identifier of the accessory 6 and the position or a change in position of the accessory 6. Here, the detector 18 is designed as an RFID reader.

The position sensing device 20 is adapted to cooperate with a corresponding element (not shown) on the accessory 6. Accordingly, the position sensing device 20 is capable of detecting correct assembly or removal or incorrect assembly or removal of the accessory 6 on the base unit 4.

The communication interface 16 is designed as a touch-sensitive screen 22 with a multifunction button 24.

The sensing device 18, the position sensing device 20, the electric motor 12 and the communication interface 16 are each connected to the controller 14 by a communication link 26, 28, 30, 32.

In the case constellation shown, the accessory 6 is first removed from the base unit 4 (left part of FIG. 1) and then assembled with the base unit 4 (right part of FIG. 1). In the position of the accessory 6 removed from the base unit 4, the communication interface 16 displays an instruction 34 to assemble the accessory 6 with the base unit 4. After assembling the accessory 6, the identifier of the accessory 6 was detected by the detector 18 and recognised by the controller 14 and, in addition, the position of the accessory 6 was also detected by the position detector 20 and recognised by the controller 14 as the proper position. Subsequently, the controller has independently and automatically confirmed the intended assembly of the correct accessory 6 and has also caused the communication interface 16 to display a corresponding user message 36.

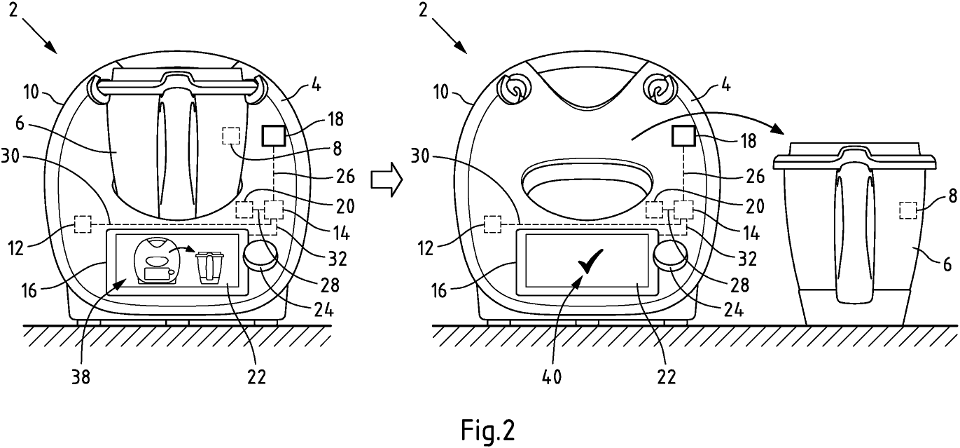

The kitchen appliance system 2 shown by FIG. 2 is the same as in FIG. 1 with the difference that the case constellation wherein the accessory 6 is removed from the base unit 4 as intended is shown.

In the left part of FIG. 2, the communication interface 16 indicates an instruction 38 to remove the accessory 6 from the base unit 4. As a result of the removal of the accessory 6 by the user, detection of the identifier of the accessory 6 by the detector 18 and corresponding recognition by the controller 14, and also detection of a change in position by the position detector 20 and corresponding recognition of the change in position as removal by the controller 14, the controller 14 has independently and automatically confirmed the intended removal of the correct accessory 6 and caused the communication interface 16 to display a corresponding user instruction 40.

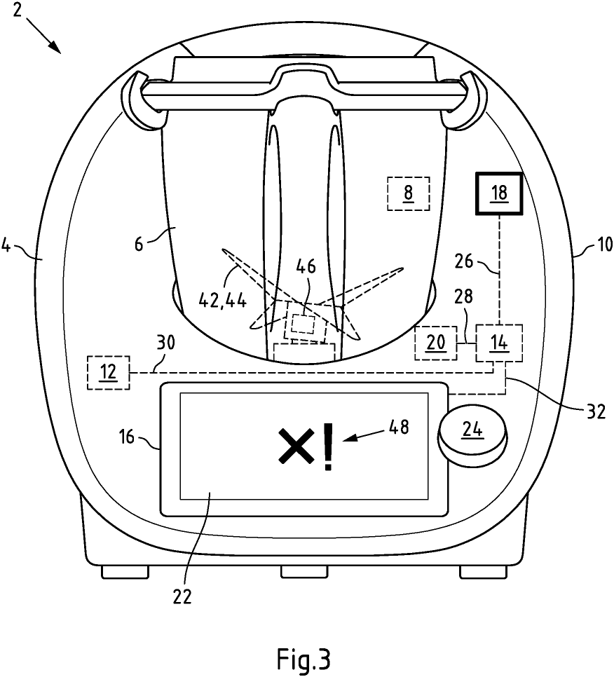

FIG. 3 shows the kitchen appliance system 2 of FIG. 1, wherein an additional, second accessory 42 is provided in the form of a cutting unit 44 with an RFID module 46 having an identifier.

The position detector 20 is also adapted to cooperate with a corresponding element (not shown) on the second accessory 42, and is thus adapted to detect correct assembly or removal or incorrect assembly or removal of the second accessory 42 in the first accessory 6.

In the constellation shown, the second accessory 42 is not correctly assembled or its position does not allow proper interaction with the electric motor 12 of the base unit 4. After detection of the identifier of the second accessory 42 by the position detector 20 and corresponding recognition of the accessory 42 by the controller 14 and also detection of the position of the second accessory 42 by the position detector 20, the controller 14 has determined by comparison with information from the database stored on its storage medium that the detected position does not correspond to any intended, designated position for this accessory 42. As a result, the controller 14 has caused the communication interface 16 to display a corresponding user message 48, in this case a warning message. Furthermore, the controller 14 prevents the second accessory 42 from being driven by the electric motor 12 until a proper position of the second accessory 42 is detected.

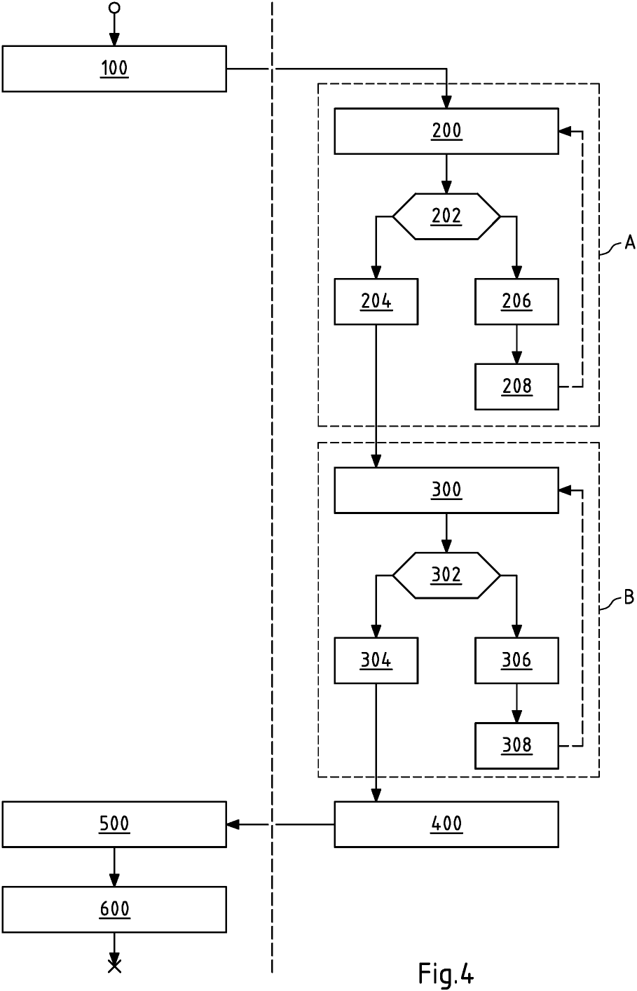

FIG. 4 shows an example of a method for controlling a kitchen appliance system 2 with a flowchart. In a first step 100, an instruction is provided to a user, wherein the instruction concerns an assembly of an accessory X.

Once the instruction is provided, an identification process with several steps begins, which are shown together in a block A. As the first step 200 of the identification process, an identifier is captured. Then, at step 202, this is compared with identifiers stored in a database.

If the comparison does not result in a match, a user message is displayed in step 206 stating that the accessory has not been recognised or is not the accessory recommended for the current preparation process. A waiting time (step 208) then starts to give the user the opportunity to assemble the correct accessory recommended for the current preparation process. After this waiting time has elapsed, the machine starts again at step 200.

If the comparison from step 202 results in a match of the detected identifier with an identifier from the database, then a position recognition process is initiated, the steps of which are grouped in block B of FIG. 4. After positive recognition of the accessory X, its position is detected in step 300 and then compared in step 302 with predefined, proper positions for the accessory X from the database.

If the comparison does not result in a match, then in step 306 a user message is output indicating that the accessory is not positioned as intended or that there is a risk of damaging the kitchen appliance system 2 and that a correction of the position to a proper position is recommended. A waiting time (step 308) then starts to give the user the opportunity to correct the position of the accessory. After this waiting time has elapsed, the system starts again at step 300.

If the comparison from step 302 results in a match, then in step 400 it is confirmed internally that the correct accessory X is positioned as intended. In step 500, the display of the instruction to assemble accessory X is then terminated. In the following step 600, the instruction for the next preparation step is displayed.

1. A kitchen appliance system,
wherein the kitchen appliance system comprises a base unit having a housing, a controller and a communication interface, and at least one accessory having an identifier,
wherein a detector is provided and is configured to detect an identifier of at least one accessory and to forward corresponding information to the controller,
wherein a position detector is provided and is configured to detect the position of the at least one accessory with respect to the base unit and/or with respect to a further accessory and to forward corresponding information to the controller,
wherein the controller is configured to recognized an accessory and its position on the basis of the forwarded information, and
wherein the controller is configured to automatically confirm a proper position or change in position of a detected accessory and to output a corresponding user instruction in the event of an improper position or change in position or in the event of an unrecognized accessory.

2. The kitchen appliance system according to claim 1,
wherein the controller is configured to
control components of the kitchen appliance system according to at least one predetermined preparation process, and
automatically adjust the course of a preparation process depending on the detected position or change in position and depending on the detected identifier.

3. The kitchen appliance system according to claim 1,
wherein the controller is configured to automatically provide instructions for preparation steps of at least one preparation process via the communication interface depending on the detected position or change in position and depending on the detected identifier.

4. The kitchen appliance system according to claim 1,
wherein an assembly or a removal of at least one accessory is recommended for carrying out a preparation step, and
wherein the controller is configured to,
upon detection of an appropriate, intended assembly or removal of the at least one recommended accessory, automatically confirm this; and
resume the corresponding preparation step or provide instructions for a subsequent preparation step.

5. The kitchen appliance system according to claim 1,
wherein the controller is configured to,
upon detection of an improper assembly or an improper removal during a first detection operation, to perform a new detection operation after a predetermined period of time has elapsed, and
provide a corresponding user message when an improper assembly or an improper removal is detected during the new detection process and to prevent a preparation step from being continued at the kitchen appliance system.

6. The kitchen appliance system according to any claim 1,
wherein for carrying out a preparation step an assembly of at least one accessory is recommended, and
wherein the controller is configured to, upon detection of the absence of the at least one recommended accessory during a first detection process, automatically provide a corresponding user indication and to carry out a renewed detection process after a predetermined period of time has elapsed.

7. The kitchen appliance system according to claim 1,
wherein an assembly of at least one accessory is required for executing a preparation step, and
wherein the controller is configured to, upon detection of the absence of the at least one required accessory
automatically provide an appropriate user message, and
prevent continuation of a preparation step at the kitchen appliance system until a proper assembly of the required accessory is detected.

8. The kitchen appliance system according to claim 1,
wherein a preparation instruction with a sequence of preparation steps with corresponding instructions is provided, and
wherein the controller is configured to skip a provision of an instruction relating to an assembly or a removal of an accessory if a corresponding proper position change of the accessory has already been detected before the provision of this instruction, and/or if a corresponding proper position is detected.

9. A method for controlling a kitchen appliance system according to claim 1,
wherein an identifier of at least one accessory is detected,
wherein the position of the at least one accessory is detected with respect to the base unit and/or with respect to a further accessory,
wherein an accessory and its position are recognized on the basis of the detected identifier and the detected position, and
wherein an proper position or change in position of a detected accessory is automatically confirmed and in the case of an improper position or change in position or in the case of an unrecognized accessory, a corresponding user message is output.

10. The method according to claim 9,
wherein components of the kitchen appliance system are controlled in accordance with at least one predetermined preparation process, the course of a preparation process being automatically adapted in dependence on the detected position or change in position and in dependence on the detected identifier.

11. The method according to claim 9,
wherein instructions for preparation steps of at least one preparation process are automatically provided via the communication interface in dependence on the detected position or change in position and in dependence on the detected identifier.

12. The method according to claim 11,
wherein an instruction relating to an assembly or removal of an accessory is skipped if a corresponding proper position or change in position of the accessory was already detected in time before this instruction was made available.

13. The method according to claim 9,
wherein assembly or removal of at least one accessory is recommended for carrying out a preparation step, and
wherein, when a corresponding, proper assembly or a corresponding, proper removal of the at least one recommended accessory is detected, this is automatically confirmed and the corresponding preparation step is completed or an instruction for a subsequent preparation step is provided.

14. The method according to claim 9,
wherein, upon detection of an improper assembly or an improper removal during a first detection operation, a new detection operation is performed after a predetermined period of time has elapsed, and
wherein, when an improper assembly or improper removal is detected during the renewed detection process, a corresponding user message is provided and a continuation of a preparation step on the kitchen appliance system is prevented.

15. The method according to claim 9,
wherein an assembly of at least one accessory is recommended for carrying out a preparation step, and
wherein, upon detection of the absence of the at least one recommended accessory during a first detection process, a corresponding user message is automatically provided and a new detection process is carried out after a predetermined period of time has elapsed, or
wherein the performance of a preparation step requires the assembly of at least one accessory, and
wherein, upon detection of the absence of the at least one required accessory, a corresponding user message is automatically provided and a continuation of a preparation step on the kitchen appliance system is prevented until a proper assembly of the required accessory is detected.

16. A computer program comprising instructions, the execution of which on at least one processor of a controller of a kitchen appliance system causes a method according to claim 9 to be carried out.
